(19) United States
(12) Patent Application Publication
(10) Pub. No.: US 2008/0153332 A1
(43) Pub. Date: Jun. 26, 2008

(54) Integrated Power Center and Mount for Flat Screen Video Displays and Projectors

(75) Inventors: Noel Lee, Las Vegas, NV (US); Anthony Dichiro, Chatsworth, CA (US); Demian Martin, San Leandro, CA (US)

Correspondence Address: LARIVIERE, GRUBMAN & PAYNE, LLP, 19 UPPER RAGSDALE DRIVE, SUITE 200, MONTEREY, CA, 93940, US

(73) Assignee: Monster Cable Products, Inc., Brisbane, CA (US)

(21) Appl. No.: 11/969,872

(22) Filed: Jan. 4, 2008

Related U.S. Application Data
(63) Continuation-in-part of application No. 11/325,617, filed on Jan. 3, 2006, now abandoned.

(51) Int. Cl. H01R 3/00

(52) U.S. Cl. 439/162

(57) ABSTRACT

A power center for use with video display devices having a housing 2 for electronic circuitry 3 for preventing electric surges adapted for attachment to a flat surface with a means for connection 4 to a source of electric current and power outlets 6, 7 attached to said housing for providing power to a video display device. A mount 21 is attached to housing 2 for attaching a video display or projector. A variety of different mounts 21 are illustrated for specific applications.

The present application is a continuation-in-part of and claims priority to U.S. patent application Ser. No. 11/325,617 filed Jan. 3, 2006.

### TECHNICAL FIELD

The present invention generally relates to video flat screen displays. More particularly, the present invention relates to an integrated mounting system for flat screen video displays with a power center adapted for such displays. Yet more particularly, the present invention relates to power centers for flat screen video displays with articulated mounts.

### BACKGROUND ART

A wide variety of amounts have been proposed for use with flat screen video displays such as plasma displays and liquid crystal displays (LCD). A number of mounts have also been designed for use with video projectors for use with front projection flat screens. Power centers for such displays have also been proposed. A problem with all of such power centers and mounts is the presence of unsightly wires connecting such displays and the undue multiplication of components. A power center for a plasma display is quite different from one for a projection display, for example. There is a long-standing need for a power center for a flat screen video display with includes a mount for the type of display for which it is suitable.

### DISCLOSURE OF THE INVENTION

The present invention addresses the current needs for a system to power and mount a flat screen video display. Embodiments of the invention are disclosed for mounting to a table, wall, ceiling or under a counter. Embodiments of the invention are capable of freedom of movement in one two or three dimensions. A variety of mounting arms may be associated with the power center for different applications.

Prior art attempts to mount flat screen monitors have usually been either cheap, flimsy mounts which come with a monitor or more expensive brackets used to mount heavy plasma screen monitors including television receivers to a wall. A large number of very expensive projector mounts have also been devised but none of these projector mounts include power centers.

Further, in the prior art, a number of power centers have been devised which are designed to fit under a cathode ray tube (CRT) monitor. Such power centers do not however include mounting means.

The present invention satisfies the needs discussed above. The present invention generally relates to power centers for flat screen monitors and projectors. More particularly, the present invention relates to a power center device capable of mounting to a variety of monitor and projector types as well as different surfaces.

Upon reading the above description, various alternative embodiments will become obvious to those skilled in the art. These embodiments are to be considered within the scope and spirit of the subject invention, which is only to be limited by the claims which follow their equivalents.

### BRIEF DESCRIPTION OF THE DRAWING(S)

For a better understanding of the present invention, reference is made to the below referenced accompanying Drawing(s). Reference numbers refer to the same or equivalent parts of the present invention throughout the several figures of the Drawing(s).

FIG. 1 is a perspective view of the power center portion of the invention.

FIG. 2 is a perspective view of the FIG. 1 embodiment with the addition of a flat profile wall mount.

FIG. 3 is a perspective view of the FIG. 1 embodiment with the addition of an extension arm mount.

FIG. 4 is a perspective view of the FIG. 1 embodiment with the addition of an articulated extension arm mount.

FIG. 5 is a perspective view of another embodiment suitable for the power center portion of the invention for use in an undercounter application in accordance with the present invention.

FIG. 6 is a perspective view of the FIG. 5 embodiment suitable for the power center portion of the invention for use in an undercounter application in accordance with the present invention including a cable management option.

FIG. 7 is a perspective view of the FIG. 5 embodiment suitable for the power center portion of the invention for use in an undercounter or ceiling application in accordance with the present invention.

FIG. 8 is a perspective view of the FIG. 5 embodiment suitable for the power center portion of the invention for use in an undercounter or ceiling application in accordance with the present invention including a cable management option.

### MODES FOR CARRYING OUT THE INVENTION

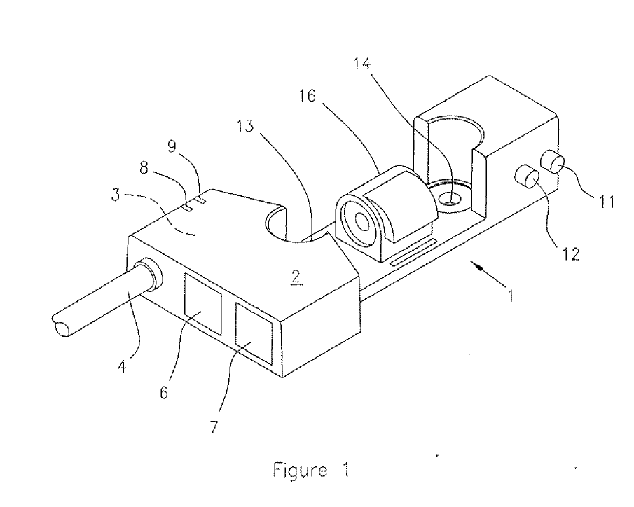

FIG. 1 is a perspective view of the power center portion of the invention. Power center 1 includes a housing 2. Housing 2 includes electronic circuitry 3 such as surge protection, voltage stabilization, conditioning, remote control, power monitoring, power cleaning, power filtering, IR/RF repeaters, amplifiers, networking, audio-video receivers and additional plug outlets (not shown). A power supply cord 4 provides a means to connect the circuitry to household power supply mains (not shown). Power outlet sockets 6 and 7 in housing 2 provide connection points to provide power to a monitor or projector (not shown). Housing 2 may also include indicators 8 and 9. Indicator 8 could be a light-emitting diode (LED), an incandescent bulb or gas discharge bulb to show that the circuitry is providing protection. Indicator 9 could also be a LED, an incandescent bulb or gas discharge bulb to indicate that power is being received through power supply cord 4. Housing 2 may also be provided with coaxial cable connectors 11 and 12 to allow protection from lightning or other surges. Housing 2 is mountable to a wall or table by means of mounting holes 13 and 14. Conventional mounting means such as screws or anchors may be used in holes 13 and 14 to mount to a solid surface. Housing 2 further includes an attachment point 16 for attachment of a mounting means (not shown) to connect housing 2. In this embodiment attachment point 16 is a pivot boss with a hole which acts as a bearing.

Power center 1 may be enhanced by additional networking functionality. The power center could, for example, contain circuitry capable of cooperating with powerline networking, HomePlug, HDPLC, and Ethernet. In the case of powerline networking, the power center could route power networking data packets around the power conditioning circuitry, so that the power networking data is preserved rather than being filtered out by the power conditioning circuitry. The power center may also contain circuitry capable of cooperating with wireless networks, such as, for example, WiFi, Bluetooth, ZigBee, Z-wave and RF. The power center could be capable of delivering media content from any attached or network attached device to a video and/or audio monitor or other attached or network attached device, in both digital and analog formats. Examples include delivery of media from a standalone personal video recorder or digital media recorder or from a personal computer. The power center could also access and deliver content from the World Wide Web. Furthermore, the power center may deliver content to or from other power centers containing compatible networking functionality. Additionally, the power center may incorporate an infrared repeating system where the system is programmed or designed to direct the IR commands to the specific product to which the IR commands need to go. The power center may include, but is not limited to, a radio mesh network system for control of lights and automated home controls, such as heating/cooling and security systems monitoring and control.

To enhance the user experience, the power center could provide a graphical user interface in the form of a browser displayed on an attached video monitor or television. Via the browser, a user would be able to access all forms of media made available through the power center. The browser would provide a menu of the various types of content available for access. To further enhance the user experience, the powercenter could automatically search for content on attached and networked devices, and index such content in a comprehensive manner in accordance with the type of content or as the user specifies. For example, digital music files may be aggregated and organized by artist and album, whereas movies are organized by genre and title. The power center may access external databases to determine the identity of a media file and retrieve file information to aid in its indexing function. Through the browser, the user would thus be able to access a given type of content in an intuitive manner regardless of the actual physical location of the content files.

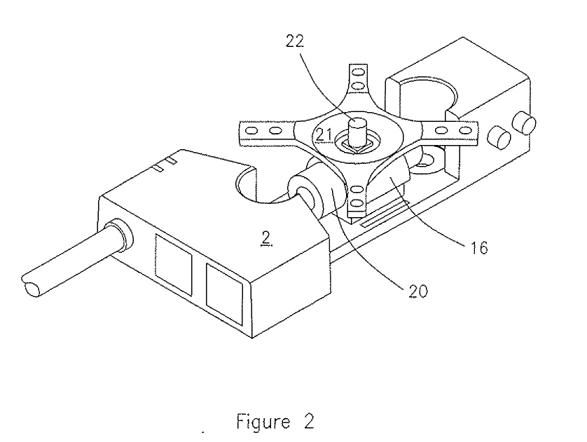

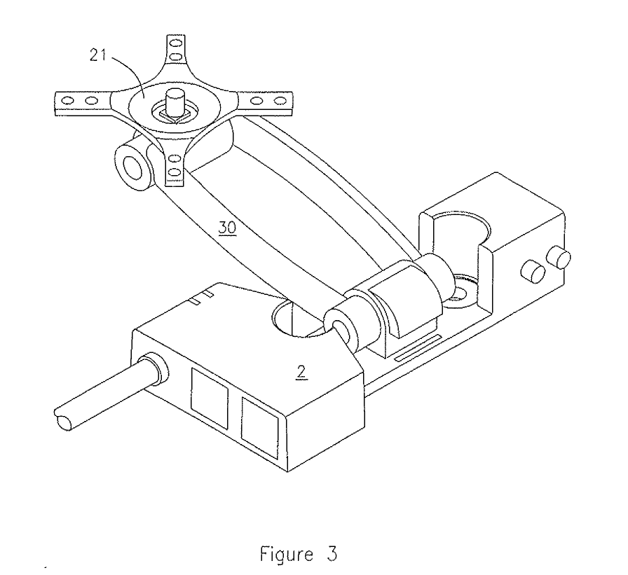

FIG. 2 is a perspective view of the FIG. 1 embodiment with the addition of a flat profile wall mount. FIG. 2 is identical to FIG. 1 except that there is a very short arm 20 attached to attachment point 16 in rotatable engagement at one end. A mounting plate 22 is attached to the other end of arm 20. In this embodiment plate 21 is adapted for attachment to a flat screen monitor and may be rotated relative to housing 2 by adjustment of a nut 22.

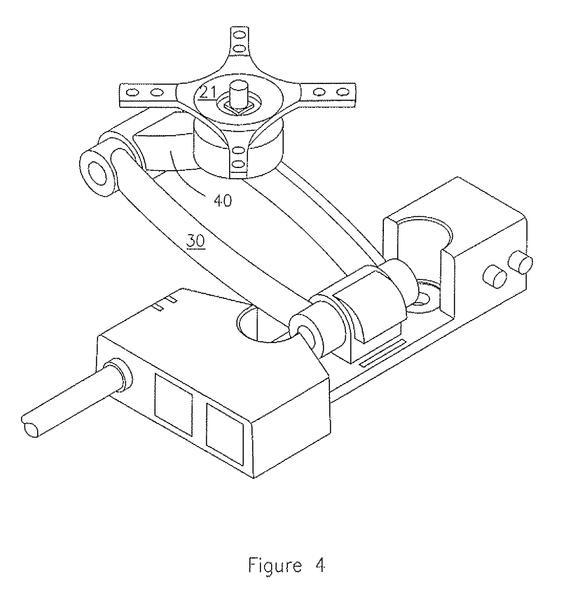

FIG. 3 is a perspective view of the FIG. 1 embodiment with the addition of an extension arm mount. The FIG. 3 embodiment is thus identical to that of FIG. 2 except that extension arm 30 is much longer than arm 20 in the FIG. 2 embodiment. This embodiment is usable on a wall but is also usable on a desk or table since mounting plate 21 may be moveable to normal to housing 2. This embodiment may also be mounted to a ceiling for use with either a wide screen monitor or a projector.

FIG. 4 is a perspective view of the FIG. 1 embodiment with the addition of an articulated extension arm mount. The FIG. 4 embodiment is thus identical to that of FIG. 3 except that articulation arm 40 is connected between arm 30 and mounting plate 21. This embodiment is also usable on a wall but is also usable on a desk or table since mounting plate 21 may be move normal to housing 2. This embodiment may also be mounted to a ceiling for use with either a wide screen monitor or a projector. This embodiment provides the greatest possible extension length.

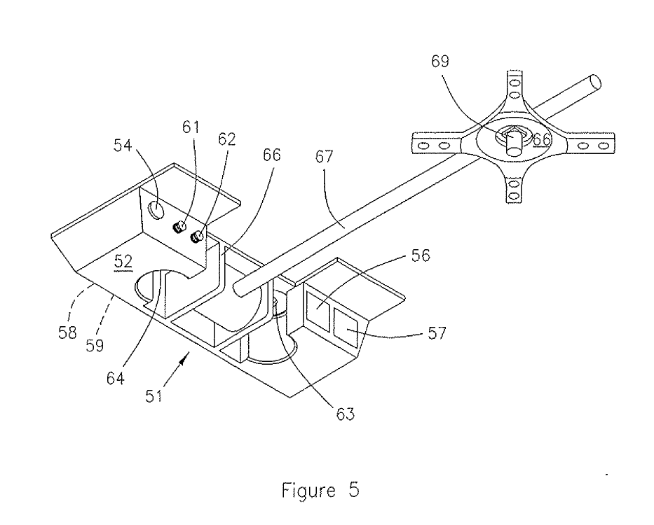

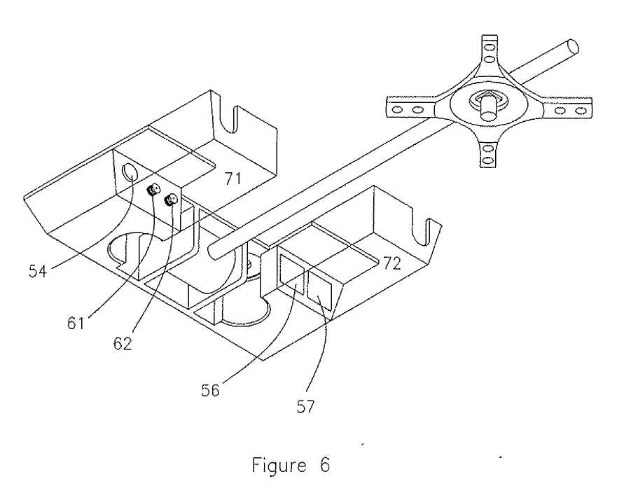

FIG. 5 is a perspective view of another embodiment of the power portion of the invention for use in an undercounter application in accordance with the present invention. Power center 51 includes a housing 52. Housing 52 includes electronic circuitry such as surge protection, voltage conditioning, remote control conceptions (not shown). A power supply cord 54 grommet provides a connection point for a power cord (not shown), a means to connect the circuitry to household power supply mains (not shown). Power outlet sockets 56 and 67 in housing 52 provide connection points to provide power to a monitor or projector (not shown). Housing 52 may also include indicators 58 and 59 on the front of the housing. Indicator 58 could be a light-emitting diode (LED) to show that the circuitry is providing protection. Indicator 59 could also be a LED to indicate that power is being received through power supply cord grommet 54. Housing 52 may also be provided with coaxial cable connectors 61 and 62 to allow protection from lightning or other surges. Housing 52 is mountable to the underside of a counter or the like by means of mounting holes 63 and 64. Conventional mounting means such as screws, bolts or anchors may be used in holes 63 and 64 to mount to the underside of a cabinet. Housing 52 further includes an attachment point 66 for attachment of a mounting means such a bar 67 to connect housing 2. In this embodiment attachment point 66 is a pivot boss with a hole which acts as a bearing. A mounting plate 68 is slidably attached to bar 67. In this embodiment plate 66 is adapted for attachment to a flat screen monitor and may be rotated relative to housing 52 by adjustment of a nut 69.

FIG. 6 is a perspective view of the FIG. 5 embodiment suitable for the power center portion of the invention for use in an undercounter application in accordance with the present invention including a cable management option. This embodiment is identical to that of FIG. 6 with the exception of the addition of cable management housing 71 and cable management housing 72. Cable management housing 71 aid is managing coaxial cables connected to connectors 61 and 62 and the power cord in grommet 54. Cable management housing 72 aids in managing power cords connected to outlets 56 and 57.

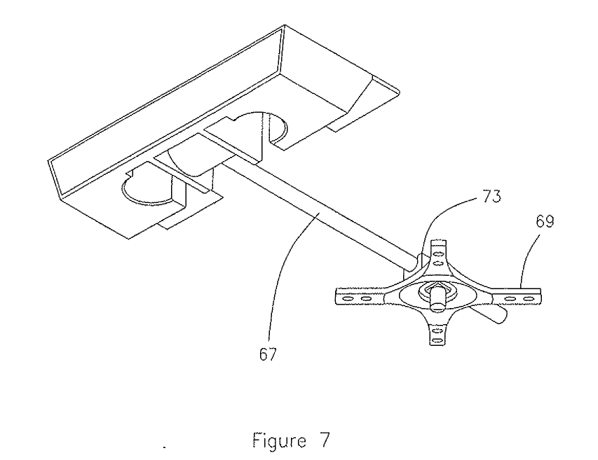

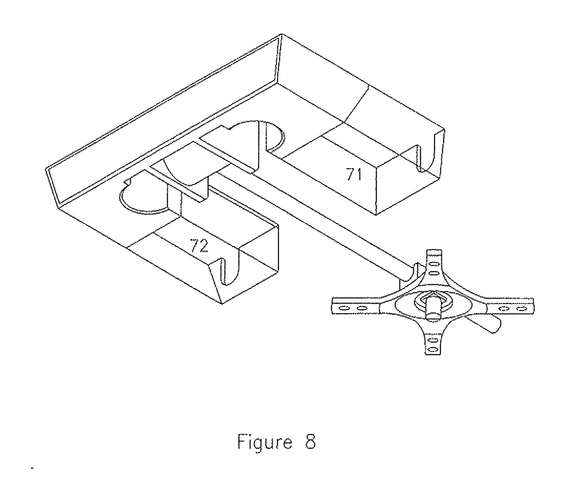

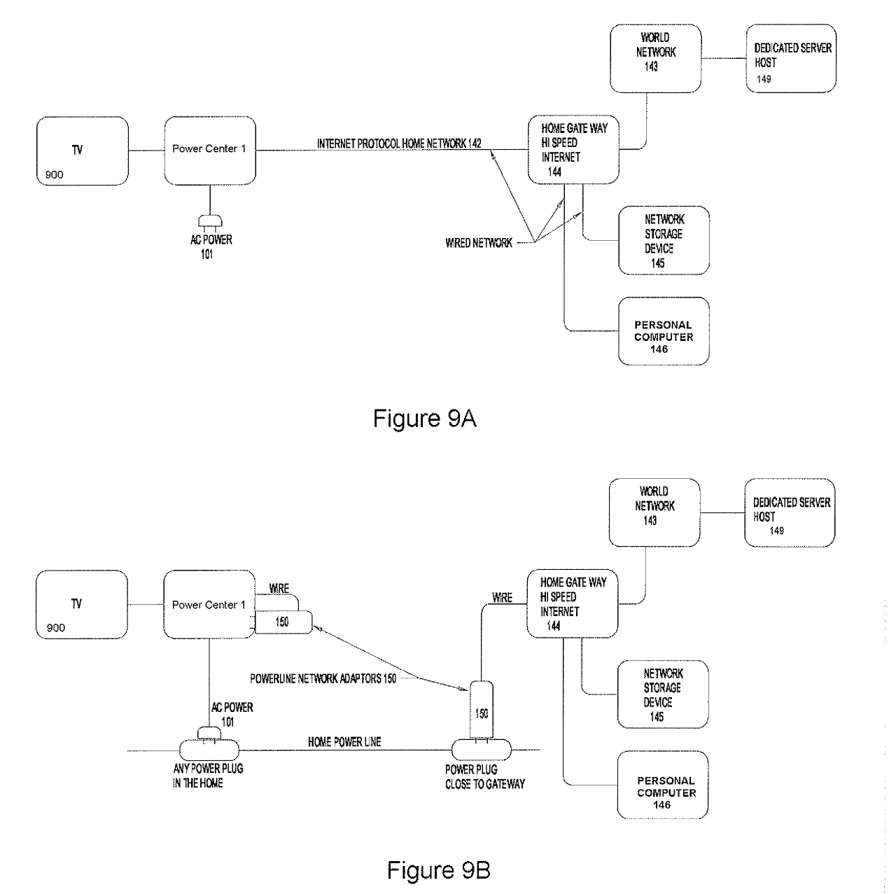

FIG. 7 is a perspective view of the FIG. 5 embodiment suitable the power center portion of the invention for use in an undercounter or ceiling application in accordance with the present invention. This embodiment is identical to the FIG. 5 embodiment except that mounting plate 69 is pivotably attached to the end of bar 67 by means of a pivot 73. This embodiment is also particularly suitable for ceiling mounting of a projector.

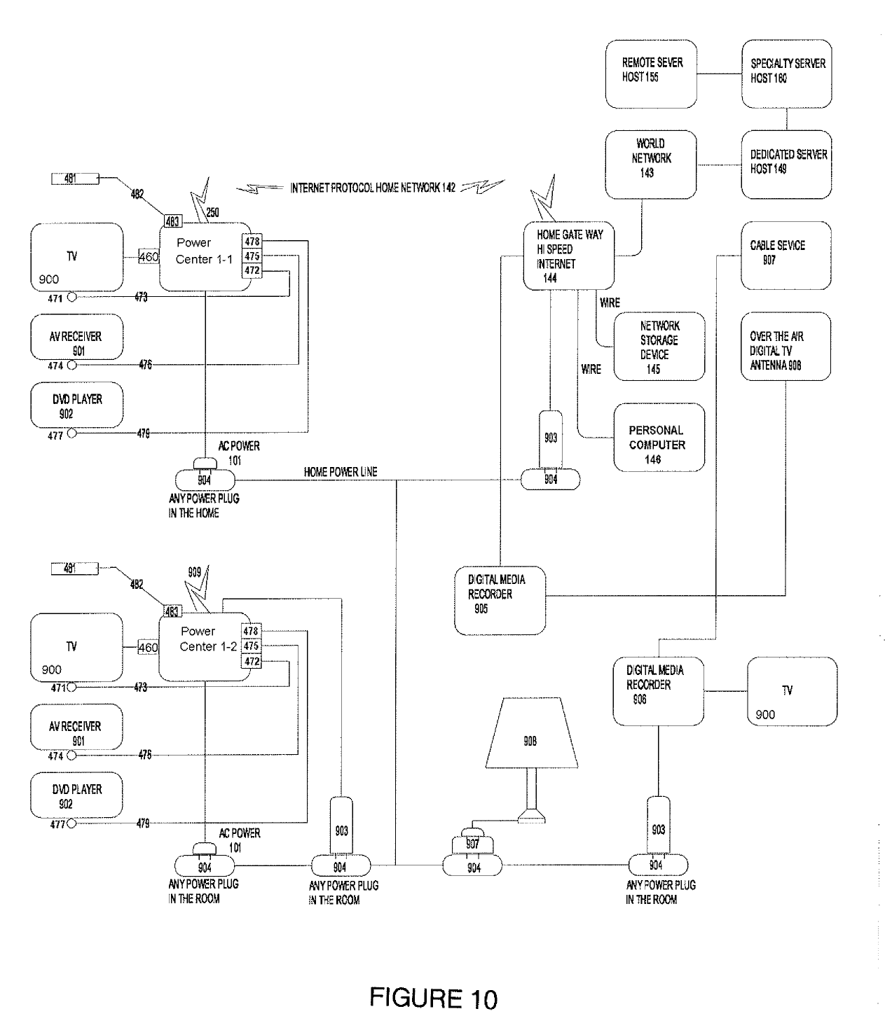

FIG. 8 is a perspective view of the FIG. 7 embodiment suitable for the power center portion of the invention for use in an undercounter or ceiling application in accordance with the present invention including a cable management option. This embodiment is identical to that of FIG. 7 with the exception of the addition of cable management housing 71 and cable management housing 72. Cable management housing 71 aid is managing coaxial cables connected to connectors 61 and 62 and the power cord in grommet 54. Cable management housing 72 aids in managing power cords connected to outlets 56 and 57.

FIG. 9A illustrates the power center of FIG. 1 in a wired network system. Power center 1 includes AC filter and protection, like a Monster Cable Products HTS1000, and is connected to the data Internet protocol home network 142 connecting data signals to the Home gateway hi speed internet 144. Other devices like but not limited to network storage device 145 and personal computer 146 are connected to the home network 142 and accessible from the power center 1 via the home network 142. The home gateway 144 which forms the home network would connect to the world network 143 and make expanded services available to the home network 142, such as from a dedicated server host 149.

FIG. 9B illustrates the AVNPC of FIG. 1 in a power line network system, with the connection to the home network being realized by the use of Intellon Homeplug AV adapter Int600 or DS2 DSS9010 (powerline network adapter 150) or other similar device built into the AVNPC 100 or as an external adapter.

FIG. 10 illustrates use of power center 1 of FIG. 1 in a system with multiple power centers and methods of connecting them to the home network. Power center 1-1 is connected to TV 900 from the media adapter interface 460, receives IR signals via the IR input 483, and receives AC power 101. Power center 1-1 connects to a Home gateway 144 via a WiFi or similar wireless network through wireless networking module 250. It is also possible to connect directly with the Ethernet interface in power center 1-1. The PC can be used to supply content or for remote control of the power center 1-1. IR cable 473 connects from IR repeater port 472 on power center 1-1 to IR emitter 471. This provides IR control of the TV from the power center to form an integrated system. This is duplicated for the AV Receiver and the DVD player. It is also possible to interconnect multiple power centers like device 1-2 such that they can share content and be controlled from each other. Power center 1-2 is connected to the home network with the use of Power line network adapter 903. It is further possible to add a Digital Media Recorder (DMR) 906 that will allow TV content and a common graphic user interface to be shared with all power centers in the home network. It is further possible for the power center 1-2 to access the World Wide Web (WWW) through a broadband Home gateway 144 via Powerline network adapter 903, WiFi, wired Ethernet or other networking media. From the WWW it is possible to access other media from a dedicated server host 149 for the system or from general purpose hosts that have content compatible with the power center 1-2. It is further possible to use powerline network adapter 903 as a gateway/connection point for other services within the home that are operated or monitored from remote server hosts like 155 or specialty server host 160 that can monitor security in the home or offer remote control of the home via the control interfaces. The present invention provides the capability for home automation with command and control, Z-wave 909 from remote control and IP to control lights 908 with a Z-wave light moguls, also IR over IP from WiFi or other means to control devices on the network in the same room having an AVNPC, or any room with an appropriately configured radio. While this embodiment focuses on a powerline network, the same principles are applicable to any network medium.

### INDUSTRIAL APPLICABILITY

The present invention applies industrially to video data reproduction, particularly display of video information, flat screen monitors and projector device systems and methods. More particularly, the present invention applies industrially to implementations that combine mounting with power control methods and devices.

What is claimed:

1. A power center for use with video display devices comprising:
a housing for electronic circuitry adapted for attachment to a flat surface;
electronic circuitry in said housing for electrical power conditioning, for connection to a source of electric current extending from said circuitry through said housing and for providing conditioned power to the video display device; and
a mount attached to said housing for attaching the video display device thereto.

2. A power center for use with video display devices as in claim 1, further comprising a means for protection of signals to a video display device attached to said mount.

3. A power center for use with video display devices as in claim 1, wherein said mount is adapted for attachment to a flat screen video display.

4. A power center for use with video display devices as in claim 1, wherein said mount is adapted for attachment to a projector.

5. A power center for use with video display devices as in claim 1, further comprising a visual indication of the state of said circuitry.

6. A power center for use with video display devices as in claim 1, wherein the electronic circuitry in said housing is selected from the group of, surge protection, voltage stabilization, conditioning, remote control, power monitoring, power cleaning, power filtering, IR/RF repeaters, amplifiers, networking, audio-video receivers and additional plug outlets.

7. An integrated mounting system for use with video display devices comprising:
a housing for electronic circuitry adapted for attachment to a flat surface;
electronic circuitry in said housing for networking and for electrical power conditioning and for connection to a source of electric current extending from said circuitry through said housing adapted for attachment to a source of electric power, and for providing conditioned power to a video display device;
a mount attached to said housing for attaching the video display device;
the electronic circuitry being selected from the group of surge protection, voltage stabilization, conditioning, remote control, power monitoring, power cleaning, power filtering, IR/RF repeaters, amplifiers, networking, and audio and video receivers.

8. An integrated mounting system for use with video display devices as in claim 7, further comprising a means for protection of signals to a video display device attached to said mount.

9. An integrated mounting system for use with video display devices as in claim 7, wherein said mount is adapted for attachment to a flat screen video display.

10. An integrated mounting system for use with video display devices as in claim 7, wherein said mount is adapted for attachment to a projector.

11. An integrated mounting system for use with video display devices as in claim 7, further comprising a means for providing a visual indication of the state of said circuitry.

12. A power center for use with video display devices as in claim 1 wherein the electronic circuitry further includes at least one power outlet.

13. An integrated mounting system for use with video display devices as in claim 7 further including at least one power outlet.

14. An apparatus as recited in claim 7, wherein said data network transceiver communicates with and receives content from a device selected from the group consisting of a digital media recorder, a personal computer, and a remote server.

15. An apparatus as recited in claim 7, further comprising a graphical user interface displayed on an attached video display for browsing and accessing media content via said data network transceiver.

16. An apparatus as recited in claim 15, further comprising processing means for searching and indexing said media content via said data network transceiver.
